(19) United States
(12) Patent Application Publication
(10) Pub. No.: US 2007/0273319 A1
(43) Pub. Date: Nov. 29, 2007

(54) Industrial Robot

(76) Inventors: Guntram Scheible, Hirschberg (DE); Berthold Dilger, Heidelberg (DE); Colin Luthardt, Vasteras (SE)

Correspondence Address: VENABLE LLP, P.O. BOX 34385, WASHINGTON, DC, 20043-9998, US

(21) Appl. No.: 10/561,167

(22) PCT Filed: Jun. 4, 2004
(86) PCT No.: PCT/SE04/00878

§ 371 Date: May 15, 2006

(30) Foreign Application Priority Data
Jun. 16, 2003 (SE) 0301786-0

(51) Int. Cl. H02J 17/00

(52) U.S. Cl. 318/560; 700/245

(57) ABSTRACT

A power supply system for an industrial robot. The power supply includes a transmitting part including a first coil and a first converter for producing an alternating magnetic field from the first coil. The power supply also includes a receiving part including a second coil for providing an alternating current by induction from the alternating magnetic field and a second converter for producing from the alternating current a direct current for providing power to a tool carried by the robot.

### TECHNICAL FIELD

The present invention concerns an industrial robot. More precisely the invention concerns a system for wireless transfer of electric power between a robot and a tool carried by the robot. Preferably the power transferred is in the region up to 5 W. Especially the invention comprises a power supply system for efficient power supply of such a tool comprising the use of air cored coils.

### BACKGROUND OF THE INVENTION

There are a whole lot of types of tools for robot operations. Some of them are simple and need only compressed air to operate. Others have a more complicated structure an need process media, such as compressed air, cooling media, electric power as well as control signaling between the robot control unit and the tool. Normally all these media, power and control wiring are collected in one process cabling which may be bundled in a flexible tube. In a known arrangement this cabling is arranged on the outside of the robot following the robot arms to the tool. Since the tool is capable of very complex movements in order to reach a position from all different sides the cabling must be very flexible to be capable of following these movements. The fact is that due to such complex twisting and bending of the cabling the individual cable parts of the cabling are often worn out or begins to operate in failure. The appearances of a loose contact is often difficult to detect and even more difficult to repair. Often the whole cabling has to be replaced. Besides, the cabling arranged on the outside of the robot is trespassing the working space and sometimes blocking the performance of the robot.

A known solution to this problem is the arrangement of the process cabling inside the robot arms, especially the upper arm. By placing the cabling near to or in the center of the rotational axes of the robot the cabling is exposed to less complicated bending and twisting. To accomplish such solutions the upper arm of such a robot must be specially designed. All shafts and motors have to be positioned away of the center axes of the robot. Still the cabling is worn and sometimes torn by this twisting movement and will sooner or later fail to operate. The presence of loose contact in only one of the parts of the cabling causes the whole cabling to be replaced. The replacement of the cabling inside the robot arms is complicated and puts the robot out of production for a considerable time. Thus there is still a need of an improved supply for the tool of an industrial robot.

A known solution to the problem of the cabling being twisted is the arrangement of a swivel device comprising a plurality of slip rings and contact shoes in trailing contact with those rings. This swivel device is often incorporated with the turning disc of the robot. The swivel comprises a stationary part attached to the tilting body of the robot and a rotating part attached to the turning disc. The tool is then attached to the rotating part of the swivel. The known swivel device is common in robot systems containing a robot with exchangeable tools. The swivel solution has a first drawback of adding weight and length to the upper arm. Thus the swivel device will harm the performance of the robot.

A second drawback of the swivel unit is the contact problem of the slip rings. There will always be infinitesimal moments of non contact, which will disturb the communication with the tool. To minimize this disturbance a plurality of contact shoes must be arranged in parallel on each slip ring. This will allow at least one contact shoe in firm contact with the slip ring. The force of the contact shoe on the slip ring must be also be increased. This lead to higher friction and to a further decrease of the performance of the robot. The slip rings and the contact shoes must be made of high quality material which is expensive. The slip ring unit also demand a regular service.

Most swivel solutions are placed between the robot and the tool. The two parts of the swivel is not detachable but in firm rotational contact with each other. Thus in a system with exchangeable tools there has to be a contact interface for connecting the tool. This interface both have a mechanical coupling, a media coupling and an electric coupling. Thus even if the swivel solves the problem of the cabling being worn by twisting there is still a contact problem in the swivel itself or in the connecting interface.

In systems with rotational parts where electric power must be transfered from a stational body to a rotational body it is known the use of a rotational transformer. From U.S. Pat. No. 5,608,771 a contact less power transfer system is previously known. The object of the system is to supply power to a rotational gantry in a computer tomography system. Thus the power supply system comprises a rotational transformer with a diameter that is sufficiently large to receive a patient. The transformer therefore has two parts separated by an air gap. Each part has a winding placed in a core of a magnetaizable material.

From U.S. Pat. No. 5,814,900 (Esser et al) a device for combined transmission of energy and electric signals is previously known. The object of the device is to provide electrical energy and control data between two components that are moveable in an environment with presence of magnetic interference fields causing noise. The device thus contain a primary coil, a secondary coil and a core of ferromagnetic material, and means for simultaneous transmission of control signals between components that are adjustable, that is rotatable, displaceable, slidable or moveable relative to each other. The core therefore comprises a first part and a second part separated by an air gap. The first part carries the primary winding and is attached to a first component. The second part carries the secondary winding and is attached to a second component. Attached to each component the device also contains a first and second antenna inside the core for exchanging control signals between the components. The main idea for providing control signaling that is not being affected by electromechanical noise is the placement of the antennas inside the core and having the antennas shielded by the core of the rotating transformer.

For use in transferring power to a tool of a robot this cored rotating transformer is far to heavy. The large core parts are expensive to produce and the ferrite material is very brittle. Thus this known device is unsuitable for use in harsh environment. In an open industrial environment the exact distance between the two cores of the transformer cannot be guarantied. Thus a small collision force on the tool would completely destroy the effectiveness of the known transformer.

From U.S. Pat. No. 6,292,069 (Michaels et al) a further rotating transformer is previously known, the object of which is to transfer power and exchange signaling between a shaft and a rotation wheel and solving the problem of leaking energy when switching between the power transfer mode and the data transfer mode. The transformer has two windings and a microprocessor controlled resonance circuit that sequentially transfer power and signals to the battery operated rotating wheel. Thus during a first period of time the transformer only transform power using the resonant circuit and during a second period the transformer only transfer signals without the use of the resonance circuit. This sequentially transfer of power necessitates the use of an electric energy storage device such as a battery in the receiving circuit. According to the known rotating transformer the coils are permanently mounted in close vicinity of each other and with a permanently adjusted airgap that matches the resonant circuit.

For powering a tool of an industrial robot the rotating ring transformer arrangement of the latter document is inconvenient because the need of a battery that makes the tool heavier. Although not addressed in the document the distance between the two coils has to be close and stable not to affect the resonance circuit. Furthermore for higher power levels and at the proposed frequency range, the intermittent controlled resonant operation results in significant harmonics, and modulation which are not allowed by regulations due to disturbance of RFID (radio frequency identification), communication and radio equipment.

Thus there is a need within the robot industry for a system for powering a tool that is simple, robust and allow an easy exchange of tools.

### SUMMARY OF THE INVENTION

A primary object of the present invention is to provide a wireless power supply for a tool of an industrial robot that overcomes the drawbacks of known such systems. A secondary object is to provide a separable and robust power supply system for an industrial robot with exchangeable tools.

This object is achieved according to the invention by a power supply system according to the features in the characterizing part of the independent claim 1 and by a method according to the features in the characterizing part of the independent claim 10. Preferred embodiments are described in the dependent claims.

According to a first aspect of the invention these objects are achieved by a power supply system for an industrial robot comprising a transmitting part attached to the industrial robot and a receiving part attached to the tool. The transmitting part comprises a first coil and a first converter for producing an alternating magnetic field from the coil. The magnetic field is generated continuously and preferably with an ideal sinusoidal wave shape. The receiving part comprises a second coil for receiving by induction from the magnetic field an alternating current and a second converter for producing a direct current to the tool. To build up a strong magnetic field with a low power rated converter the current in the first coil is increased by arranging a resonance circuit in the first converter. Since the resonance circuit is dependent on the distance between the two coils the resonance circuit is sensing the circuit impedance and changing the frequency to withhold the resonance of the magnetic field generation. In a further embodiment the converter is matching the impedance of the resonant circuit to withhold the frequency of the resonance circuit.

By arranging the transmitting part on the industrial robot and the receiving part on the tool the additional weight to the robot is kept very small or even less compared to a traditional system with cables or involving slip rings. Also the longitudinal erection of the tool interface is kept smaller than traditional solutions.

According to a second aspect of the invention these objects are achieved by a method for supplying power to a tool carried by an industrial robot. In this method a direct current from a robot control unit is converted to a alternating current for feeding a first coil attached to the robot to produce a magnetic field carrying the power. A second coil receives the magnetic field and produce by induction an alternating current which is fed to a second converter attached to the tool to transform the alternating current into a direct current for feeding the tool with electric power. The first coil and the first converter are arranger in a resonance circuit to produce a strong alternating current in the first coil in order to produce a strong magnetic field, in which the second coil is receiving the transferred power. The resonance circuit is also made adjustable to account for the fact that the impedance due to difference in distance, coaxially and skewing is changing.

To build up a strong magnetic field the current in the first coil is increased by arranging a resonance circuit in the first converter. Since the resonance circuit is dependent on the distance between the two coils the resonance circuit is sensing the circuit impedance and changing the frequency to withhold the resonance of the magnetic field generation. In a further embodiment the converter is matching the impedance of the resonant circuit to withhold the frequency of the resonance circuit.

When the tool is detached from the robot the receiving part including the second coil and the second converter will follow the tool. Thus every tool in the system carries its own receiving part and coil. For best performance of the power transmission between the two coils should be place close to each other in parallel planes and rotating coaxially. Since the tools is detachable and the transmitting part must be working with a plurality of receiving parts that may have different coils this accuracy is hard to accomplish. The transmitting part thus has to produce a greater magnetic field than would be necessary with a system with two permanently mounted coils. According to the invention this greater efficiency is achieved by increasing the current in the coil. This is accomplished by a resonant circuit including the coils. In a system with permanently mounted coils this is an easy task but when the distance, the coaxially and the skewing is changing in time and by different tools the resonant circuit has to be self adjusting. The self adjusting capability will also adjust the resonance circuit for small displacements as a result of small collisions absorbed by the tool. Thus when any parameter in the resonance circuit changes the converter senses this and changes either the impedance or the frequency to maintain a great current flow in the first coil.

In a preferred embodiment of the invention the coils are arranged coaxially with the longitudinal axis of the tool. The coil comprises one or a plurality of windings and are preferably arranged in parallel planes. The form of the coil is arbitrary and comprises any two-dimensional or three-dimensional embodiment that forms a loop. In one embodiment the coil comprises a printed circuit board where the windings are accomplished in one or both sides of the board. In another embodiment the winding comprises circuit boards with multilayer of conductive film arrangement. In a further embodiment the coil and the attachment means are flexible. The coil in this embodiment is formed in a loop by one or a plurality of winding containing a wire. By this embodiment the coil is capable of absorbing a force from a collision and yet regaining its form after the force has disappeared. The coil may be covered by a insulating tube arrangement or even comprises a winding of an insulated cable. Also the attachment means may be flexible and contain spring arrangement.

In a preferred embodiment of the invention the converter comprises a microprocessor unit or a computer. The unit comprises memory means for storing a computer program that is controlling the power transfer and the resonance circuit. Preferably such a computer program contains instructions for the processor to perform the method as described above. In one embodiment the computer program is provided on a computer readable carrier such as a CD rom. In another embodiment of the invention the program is provided at least in parts over a network such as the Internet. For receiving data or computer program code the computer unit has a communication link with a local area network. This link may comprise a wireless system, a direct contact system or as an overlay on the power supply.

In another preferred embodiment of the invention only the first coil is arranged coaxially with the longitudinal axis of the tool. The coil comprises one or a plurality of windings as described above. The second coil in this embodiment comprises a small eccentrically positioned ferrite core that will “sniff” around the first coil. The ferrite core will amplify the leakage field near the first coil. The winding of this embodiment of the second coil comprises a cupper wire or a printed circuit board (PCB). The core comprises a simple cylinder or cube shaped body. In a preferred embodiment the core comprises a V-shaped or a U-shaped body.

In a further preferred embodiment of the invention the operation of the second part of the power system is arranged for an adjustable resonant behavior. The resonant circuit is then adjusted to the frequency of the magnetic field in order to maximize the power transfer. In a further embodiment also resonant tuning to a pre-determined frequency may be applied by controllable or switching capacitors and/or inductors.

### BRIEF DESCRIPTION OF THE DRAWINGS

Other features and advantages of the present invention will become more apparent to a person skilled in the art from the following detailed description in conjunction with the appended drawings in which:

FIG. 1 is an industrial robot carrying a power supply system according to the invention,

FIG. 2 is a brief sketch of a power supply system according to the invention,

FIG. 3 is a brief sketch of another embodiment of the power supply system, and

FIG. 4 is a coil arrangement according to the invention.

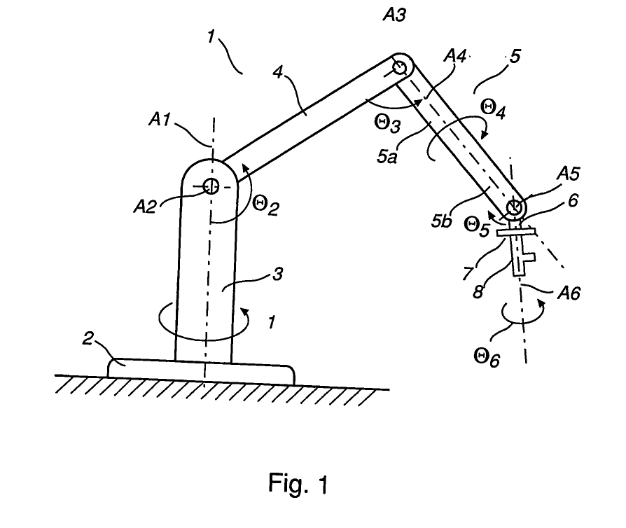

### DETAILED DESCRIPTION OF THE INVENTION

An industrial robot 1 according the invention contains a stationary foot 2 which carries a stand 3 rotatably arranged around a first axis A1. The stand carries a first robot arm 4 rotatably arranged around a second axis A2. The first arm carries a second robot arm 5 rotatably arranged around a third axis A3. The second arm 5 comprises an inner arm part 5a and an outer arm part 5b. The inner arm part carries the outer arm part, which is rotatably arranged around a forth axis A4, which is coaxial with the longitudinal axis of the inner arm part. The outer arm part carries a wrist part 6 rotatably arranged around a fifth axis A5. The wrist part carries a hand part or a rotating disc 7, which is rotatably arranged around a sixth axis A6. Finally the rotating disc carries a tool 8 for operation by the robot.

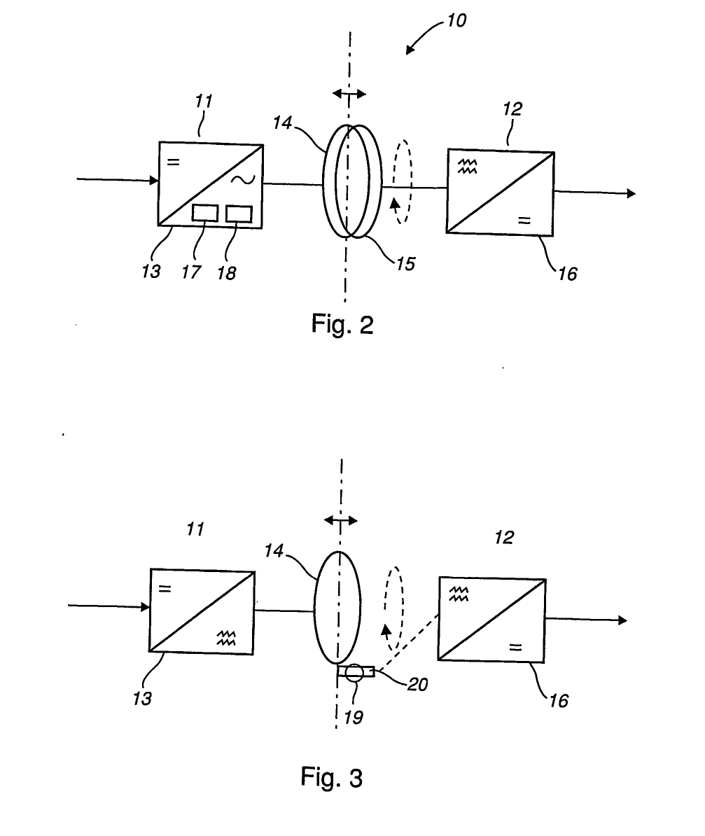

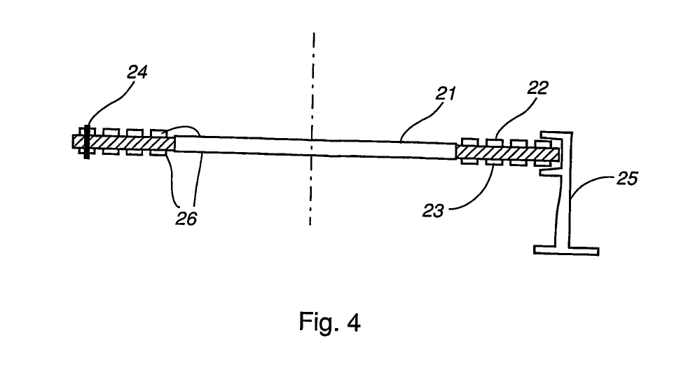

The power supply system 10 according to FIG. 2 comprises a first part 11 and a second part 12. The first part is attached to the industrial robot 1 and the second part is attached to the tool 8. The first part comprises a first converter 13 for producing an alternating current and a first coil 14 for producing a magnetic field. The second part comprises a second coil 15 for receiving the magnetic field and a second converter 16 for producing a direct current to the tool. The first part and the second part are rotatably arranged side by side with each other in a contactless manner. According to the invention the first part 11 of a power supply system 10 is attached to the turning disc 6 and the second part 12 of the power supply 10 is attached to the tool 8.

The first converter comprises means for accomplishing a resonant circuit for increasing the current in the first coil. Thereby is the first coil capable of erecting a great magnetic field which will carry the power to the second coil. In a preferred embodiment the converter also comprises a microprocessor unit 17 and memory means 18 for storing data and a computer program for controlling the converter. The second coil receives the magnetic field which creates a resonance circuit with the second converter. The second converter is capable of separating the power transfered in the resonance circuit. The converter thereafter produces a direct current for the power supply of the tool.

The power supply system according to FIG. 3 is a further preferred embodiment of the invention. The first part 11 of the power supply is the same as the power supply in FIG. 2, thus including a first converter 13 and a first coil 14. The second part 12 of the power supply comprises in this embodiment a second converter 16 and a smaller coil 19 in the periphery of the first coil 14. To strengthen the capability of receiving the magnetic field produced by the first coil the second coil comprises a core 20 of ferromagnetic material. This embodiment of the invention is specially useable with tool arrangement that do not allow the ring formed coil arrangement as presented in FIG. 2.

In one embodiment of the invention, according to FIG. 3, the coil comprises a printed circuit board 21 on which is printed a first conducting film layer 22 for forming the coil. The printed board also comprises a second printed conducting layer 23 on the back. A wire 24 is soldered on each side of the circuit board for connecting the first conducting layer with the second conducting layer, thus forming from the layers on each side a coil with a plurality of windings. The printed circuit board may conveniently be fastened with brackets 25 of a insulating material, such as plastic. In the figure the connecting threads 26 are principally illustrated.

While the invention has been specifically described in connection with the accompanied figures of specific embodiment it should be understood that various alternative embodiments of the invention described may be employed in practicing the invention. It is intended that the following claims define the scope of the invention and that the system and method within the scope of these claims and their equivalents be covered thereby. Thus the invention may involve a plurality of coils in the second part of the power supply system.

1. A power supply system for an industrial robot, comprising:
a transmitting part including a first coil and a first converter for producing an alternating magnetic field from the first coil, and
a receiving part comprising a second coil for providing an alternating current by induction from the alternating magnetic field and a second converter for producing from the alternating current a direct current for providing power to a tool carried by the robot,
wherein the transmission part is attached to the industrial robot, wherein the receiving part is attached to the tool, wherein the transmitting part comprises a tunable resonance electric circuit and wherein the second coil is detachable from the first coil.

2. The power supply system according to claim 1, wherein the first coil and the second coil are arranged coaxially.

3. The power supply system according to claim 1, wherein the first coil and the second coil are arranged in parallel planes.

4. The power supply system according to claim 1, wherein the first coil and the second coil comprises a ring-shaped form.

5. The power supply system according to claim 1, wherein the first coil and the second coil comprises a printed circuit board.

6. The power supply system according to claim 1, wherein the second coil comprises a core of magnetaizable material.

7. The power supply system according to claim 1, wherein any of the first converter and the second converter comprises a control unit containing a microprocessor and memory means.

8. A method for supplying power to a tool carried by an industrial robot, wherein a direct current is provided to a transmitting part of a power supply system comprising a first coil and a first converter, the direct current is converted by the first converter and the first coil for producing an alternating magnetic field, a second coil of a receiving part of the power supply system is arranged to produce by induction an alternating current from the magnetic field, and the alternating current is converted into a direct current by a second converter of the receiving part of the power supply system, the method comprising:
attaching the first coil to the industrial robot,
attaching the second coil to the tool and detachable from the first coil, and
arranging the first coil and the first converter in a resonance circuit, thereby increasing the current in the first coil thus producing an increased magnetic field.

9. The method according to claim 8, wherein the resonance circuit comprises an adjustable resonance circuit in order to account for variations in the impedance of the circuit due to incompleteness of the alignment of the first coil and second coil.

10. An industrial robot, comprising:
a power supply system according to claim 1.

11. A computer program products, comprising:
instructions for affect a processor to perform the method according to claim 8.

12. The computer program product according to claim 11 provided at least in part over a network such as the Internet.

13. A computer readable medium containing a computer program product according to claim 11.
